(19) United States
(12) Patent Application Publication
(10) Pub. No.: US 2018/0292048 A1
(43) Pub. Date: Oct. 11, 2018

(54) Pressure Vessel Having Continuous Fibers

(71) Applicant: Bayerische Motoren Werke Aktiengesellschaft, Muenchen (DE)

(72) Inventors: Hans-Ulrich STAHL, Muenchen (DE); Oemer AHMET-TSAOUS, Muenchen (DE); Olivier COUSIGNE, Wielenbach-Haunshofen (DE); Timo CHRIST, Muenchen (DE)

(21) Appl. No.: 16/009,483

(22) Filed: Jun. 15, 2018

Related U.S. Application Data
(63) Continuation of application No. PCT/EP2016/076392, filed on Nov. 2, 2016.

(30) Foreign Application Priority Data
Dec. 17, 2015 (DE) 10 2015 225 690.1

(51) Int. Cl. F17C 1/06

(52) U.S. Cl. CPC F17C 1/06; F17C 2201/0109; F17C 2203/0663; F17C 2203/012; F17C 2270/0168; F17C 2209/2154; F17C 2221/012; F17C 2223/0123; F17C 2223/036; F17C 2203/0604

(57) ABSTRACT

A method produces a pressure vessel having at least one fiber-reinforced layer. The reinforcing fibers of the fiber-reinforced layer are formed of at least one endless fiber. The modulus of elasticity of the at least one endless fiber is varied.

### CROSS REFERENCE TO RELATED APPLICATIONS

This application is a continuation of PCT International Application No. PCT/EP2016/076392, filed Nov. 2, 2016, which claims priority under 35 U.S.C. §119 from German Patent Application No. 10 2015 225 690.1, filed Dec. 17, 2015, the entire disclosures of which are herein expressly incorporated by reference.

### BACKGROUND AND SUMMARY OF THE INVENTION

The technology disclosed herein relates to a method for producing a pressure vessel having at least one fiber-reinforced layer, and to a pressure vessel. The endless (continuous) fibers of the fiber-reinforced layer have, according to the invention, a variable modulus of elasticity.

Pressure vessels for storing fuel are known from the prior art. These pressure vessels comprise fiber-reinforced layers which are applied, for example, by braiding or winding. Such pressure vessels are typically wound or braided using one type of fiber. In the case of the fibers of identical rigidity, the tension in the circumferential direction of the pressure vessel under internal pressure of the vessel is higher on the internal side of the pressure vessel wall than on the external side. The degree of utilization of the individual fibers in the fiber-reinforced layer is therefore not optimal. From DE 10 2006 043582 B3 it is further known to use different types of fibers for different layers, wherein the external layer has a higher elongation at break.

It is an object of the technology disclosed herein to minimize or to alleviate the disadvantages of the previously known solutions. Further objects are derived from the advantageous effects of the technology disclosed herein.

The technology disclosed herein relates to a pressure vessel for a motor vehicle, for storing fuel. Such a pressure vessel can be, for example, a cryogenic pressure vessel or a high-pressure gas vessel. High-pressure gas vessel systems are configured for permanently storing fuel (for example hydrogen) substantially at environmental temperatures at a maximum operating pressure (also referred to as MOP) above approx. 350 bar(g) (=bar above atmospheric pressure), furthermore preferably of above approx. 500 bar(g), and particularly preferably of above approx. 700 bar(g). The cryogenic pressure vessel system includes a cryogenic pressure vessel. The cryogenic pressure vessel can store fuel in the liquid or supercritical aggregate state.

The pressure vessel can have a liner. The liner is the hollow body in which the fuel is stored. The liner can be produced, for example, from aluminum or steel, or from alloys thereof. The liner can furthermore preferably be produced from a plastic, or else a linerless pressure vessel can be provided.

The pressure vessel has at least one fiber-reinforced layer. The fiber-reinforced layer can, at least in regions, surround a liner. The fiber-reinforced layer is often also referred to as laminate or sheathing, respectively, or armor. The term “fiber-reinforced layer” is used mostly herein. Fiber-reinforced plastics (also FRP for short), for example carbon fiber-reinforced plastics (CFRP) and/or glass fiber-reinforced plastics (GFRP) are typically used as a fiber-reinforced layer. The fiber-reinforced layer expediently comprises reinforcement fibers that are embedded in a plastics matrix. In particular, the matrix material, the type and proportion of reinforcement fibers, and the orientation of the latter can be varied in order for the desired mechanical and/or chemical properties to be set. The fiber-reinforced layer preferably comprises at least one endless fiber as the reinforcement fiber, which can be applied by winding and/or braiding. The fiber-reinforced layer typically has cross-wound and circumferentially-wound tiers. Cross-wound tiers are wound or braided, respectively, across the entire surface of the winding core in order for axial tensions to be compensated for. The so-called circumferentially-wound tiers which ensure a reinforcement in the circumferential direction are typically located additionally to the cross-wound tiers in the cylindrical shell region. The circumferentially-wound tiers run in the circumferential direction U of the pressure vessel and are orientated at an angle of almost 90° in relation to the longitudinal axis A-A of the pressure vessel.

The fiber-reinforced layer comprises at least two fiber tiers. The fiber tiers of the fiber-reinforced layer are tiers of reinforcement fibers which are disposed on top of one another within the fiber-reinforced layer. The fibers of one tier are disposed substantially in one plane. The at least one endless fiber herein extends across at least two fiber tiers of the fiber-reinforced layer. In other words, at least two fiber tiers are produced in an uninterrupted manner from the one and the same endless fiber(s). An endless fiber is in particular a filament of at least 1 m in length. In particular, the at least one endless fiber in the at least two of the fiber tiers has a different modulus of elasticity. In other words, it is the modulus of elasticity per se of the endless fiber(s) processed that changes within the tiered construction of the fiber-reinforced layer. The mechanical properties of the fiber-reinforced layer can thus be advantageously varied without other parameters, such as the matrix material, the tiered construction, the fiber 5 volume, etc., having to be adapted. For example, the rigidity can thus be varied within the circumferentially-wound tiers in the shell region, without the fiber orientation and/or the fiber content having to be changed.

The at least one endless fiber is particularly preferably configured as a bundle of endless fibers, also referred to as a roving.

The at least one endless fiber can preferably extend across at least 50%, or at least 80%, or at least 90%, or across 100% of the fiber tiers, wherein the endless fibers at least in portions have a different modulus of elasticity, in particular depending on the spacing of said endless fibers from the longitudinal axis A-A of the pressure vessel. The modulus of elasticity of the at least one endless fiber preferably increases as the radius of the pressure vessel increases.

The technology disclosed herein furthermore relates to a method for producing a pressure vessel, in particular the pressure vessel disclosed herein, having at least one fiber-reinforced layer. The reinforcement fibers of the fiber-reinforced layer are configured from at least one endless fiber. The modulus of elasticity of the at least one endless fiber is varied. The method disclosed herein can comprise the following step: configuring a plurality of fiber tiers of the fiber-reinforced layer, wherein the at least one endless fiber extends across at least two fiber tiers, and wherein the modulus of elasticity of the at least one endless fiber is varied in such a manner that the at least one endless fiber in one fiber tier of the at least two fiber tiers has another modulus of elasticity than in another fiber tier of the at least two fiber tiers. The method disclosed herein can comprise the step according to which the modulus of elasticity of the at least one endless fiber is varied prior to the configuration of the at least two fiber tiers. The method disclosed herein can comprise the step according to which the at least one endless fiber having the variable modulus of elasticity is wound onto a storage roll prior to the configuration of the at least two fiber tiers.

The method disclosed herein can comprise the step according to which the modulus of elasticity of the at least one endless fiber is varied by varying at least one parameter during a heat treatment of the at least one endless fiber. For example, the temperature, the time, and/or the inert gas can be varied while carbon fibers are graphitized. The method disclosed herein can comprise the step according to which the at least two fiber tiers of the fiber-reinforced layer are configured by braiding and/or winding and/or depositing pre-fabricated semi-finished fiber tiers. The method disclosed herein can comprise the step according to which the at least one endless fiber extends across at least 50%, or at least 80%, or at least 90%, or across 100% of the fiber tiers.

In other words, the use of reinforcement fibers which indeed are of a substantially identical strength but nevertheless are of different rigidity is disclosed herein. For the internal side of the pressure vessel wall (or of an internal layer of the fiber-reinforced layer, respectively) reinforcement fibers are preferably used that have a lower rigidity than the reinforcement fibers which are disposed in an external layer that surrounds the internal layer. The rigidity increases as the pressure vessel radius R increases. The reinforcement fibers having the highest rigidity are preferably provided on the external side of the pressure vessel. The reinforcement fibers can be applied by winding and/or braiding and/or depositing pre-fabricated semi-finished fiber tiers. For example, fibers from different packages having in each case different rigidities can be used for different regions of the pressure vessel wall (inside-center-outside). The production of a fiber package of which the rigidity varies across the unwinding length can be provided in particular for large commercial quantities. The rigidity can be set, for example, by the temperature in the production of the carbon fiber. The variation in the rigidity in the pressure vessel wall having the radius enables that at the bursting pressure (design pressure) ideally all reinforcement fibers are under stress up to the limit strength of said reinforcement fibers. The theoretical degree of fiber utilization is thus 100%. The thickness of the pressure vessel wall can advantageously be reduced. The dimensions and the weight of the pressure vessel can advantageously be reduced. The pressure vessel can become more cost effective since less FRP material is used in the production. The pressure vessel can typically store a larger quantity of fuel in the same installation space.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic view of a pressure vessel 100.

FIG. 2 is a schematic detailed view of a fiber-reinforced layer 120.

### DETAILED DESCRIPTION OF THE DRAWINGS

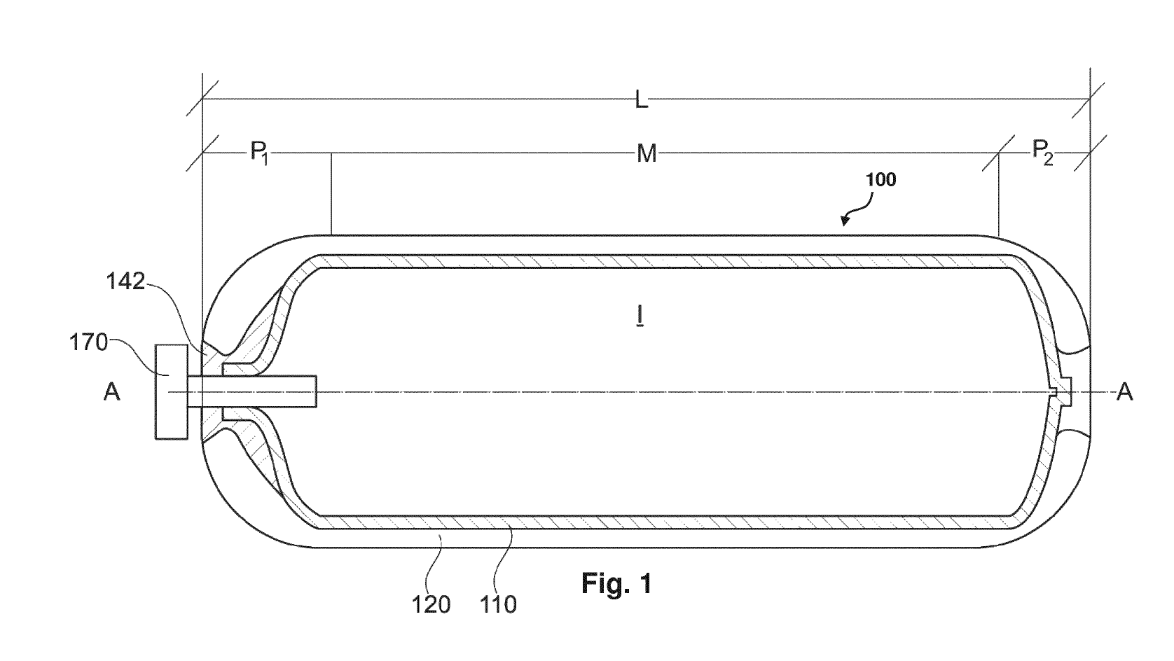

FIG. 1 shows a schematic view of a pressure vessel 100. The pressure vessel 100 has a liner 110 and a fiber-reinforced layer 120 which surrounds the liner 110 and reinforces the latter. The liner 110 provides the internal volume I for storing fuel. The pressure vessel 100 has a shell region M and polar cap regions P1, P2. An outlet 170 (not described in more detail here) is provided at the end 142 of the pressure vessel 100.

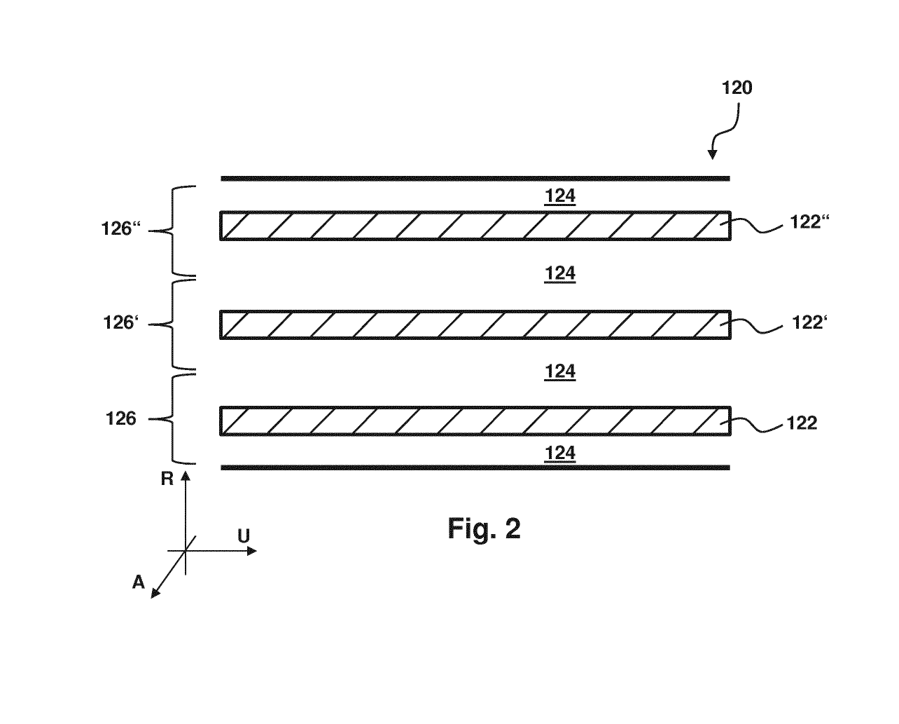

FIG. 2 schematically shows a detailed view of a fiber-reinforced layer 120. The reinforcement fibers 122, 122′, 122″ here are disposed in the circumferential direction U of the pressure vessel 100. The fragment chosen herein in relation to the vessel diameter is so small that the curvature of the vessel cannot be seen in the image. For example, such reinforcement fibers 122, 122′, 122″ are disposed in the shell region M of the pressure vessel 100. The reinforcement fibers 122, 122′, 122″ of the various fiber tiers 126, 126′, 126″ here are mutually parallel. The fiber tiers 126, 126′, 126″ are disposed on top of one another. Schematically shown here are three fiber tiers 126, 126′, 126″ which could be disposed anywhere in the fiber-reinforced layer 120. The fiber tiers 126, 126′, 126″ can be disposed so as to be directly adjacent or else so as to be separated by other fiber tiers. The individual portions 122, 122′, 122″ of the at least one endless fiber 122, 122′, 122″ here configure the respective reinforcement fibers 122, 122′, 122″ of the fiber tiers 126, 126′, 126″. In particular, the external portion 122″ of the endless fiber which in the radial direction R is spaced further apart from the longitudinal axis A-A of the pressure vessel has a higher modulus of elasticity and thus a higher rigidity than an internal portion 122 of the endless fiber.

It can thus be advantageously achieved that all reinforcement fibers are stressed in a uniform or more uniform, respectively, manner up to the limit strength. Should these portions 122, 122′, 122″ be produced from an endless fiber, a continuous and thus time-saving winding or braiding process, respectively, can thus moreover be established. The reinforcement fibers 122, 122′, 122″ of the fiber tiers here are held by a matrix material 124. Any matrix material can be used as the matrix material 124.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a pressure vessel having at least one fiber-reinforced layer, the method comprising the acts of:
configuring reinforcement fibers of the fiber-reinforced layer from at least one endless fiber, wherein
a modulus of elasticity of the at least one endless fiber is varied.

2. The method as claimed in claim 1, further comprising the acts of:
configuring a plurality of fiber tiers of the fiber-reinforced layer, wherein
the at least one endless fiber extends across at least two fiber tiers, and
the modulus of elasticity of the at least one endless fiber is varied such that the at least one endless fiber in one fiber tier of the at least two fiber tiers has a different Young's modulus than in another fiber tier of the at least two fiber tiers.

3. The method as claimed in claim 2, wherein
the modulus of elasticity of the at least one endless fiber is varied prior to the act of configuring the at least two fiber tiers.

4. The method as claimed in claim 3, wherein
the at least one endless fiber having the varying modulus of elasticity is wound onto a storage roll prior to the act of configuring the at least two fiber tiers.

5. The method as claimed in claim 2, wherein
the at least one endless fiber having the varying modulus of elasticity is wound onto a storage roll prior to the act of configuring the at least two fiber tiers.

6. The method as claimed in claim 1, wherein
the modulus of elasticity of the at least one endless fiber is varied by varying at least one parameter during a heat treatment of the at least one endless fiber.

7. The method as claimed in claim 4, wherein
the modulus of elasticity of the at least one endless fiber is varied by varying at least one parameter during a heat treatment of the at least one endless fiber.

8. The method as claimed in claim 2, wherein
the at least two fiber tiers of the fiber-reinforced layer are configured by braiding, winding and/or depositing prefabricated semi-finished fiber tiers.

9. The method as claimed in claim 2, wherein
the at least one endless fiber extends across at least 80% of the fiber tiers.

10. A motor vehicle pressure vessel, for storing fuel, comprising:
at least one fiber-reinforced layer, wherein
the fiber-reinforced layer comprises at least one endless fiber,
the at least one endless fiber extends across at least two fiber tiers of the fiber-reinforced layer, and
the at least one endless fiber in the at least two of the fiber tiers has a different modulus of elasticity.

11. The pressure vessel as claimed in claim 10, wherein
the at least one endless fiber extends across at least 80% of the fiber tiers.

12. The pressure vessel as claimed in claim 11, wherein
the modulus of elasticity of the at least one endless fiber increases as a radius of the pressure vessel increases.

13. The pressure vessel as claimed in claim 10, wherein
the modulus of elasticity of the at least one endless fiber increases as a radius of the pressure vessel increases.

14. The pressure vessel as claimed in claim 10, wherein
the different modulus of elasticity is a different Young's modulus.
